(19) United States
(12) Patent Application Publication
(10) Pub. No.: US 2006/0089828 A1
(43) Pub. Date: Apr. 27, 2006

(54) Pattern solutions

(75) Inventors: Grant J. Larsen, Littleton, CO (US); Mark H. Linehan, Yorktown Heights, NY (US); Michael Starkey, British Columbia (CA)

Correspondence Address: IBM - Intellectual Property Law Dept., 8051 Congress Avenue, Boca Raton, FL, 33487, US

(73) Assignee: INTERNATIONAL BUSINESS MACHINES CORPORATION, Armonk, NY (US)

(21) Appl. No.: 11/027,067

(22) Filed: Dec. 30, 2004

Related U.S. Application Data
(60) Provisional application No. 60/622,271, filed on Oct. 25, 2004.

(51) Int. Cl. G06F 9/45

(52) U.S. Cl. 703/22

(57) ABSTRACT

A method, apparatus and computer program product is provided for creating and implementing a pattern solution by specifying one or more patterns and creating a pattern solution recipe which documents guidance related to use, organization and interconnection the patterns. The pattern solution recipe permits substitution of one or more specified pattern with a substitute pattern. The pattern solution is transformed (creating a pattern solution implementation) by implementing each pattern as a parameterizable computer accessible object. These parameters provide a point of customization. The pattern solution recipe is implemented as another computer accessible object providing further refined guidance on the use of the implemented pattern solutions. Pattern solutions knit many patterns together using the pattern solution recipe.

### CROSS-REFERENCE TO RELATED APPLICATIONS

This patent application claims the benefit under 35 U.S.C. § 119(e) of presently pending U.S. Provisional Patent Application 60/622,271, entitled MODEL DRIVEN DEVELOPMENT PRODUCTS, filed on Oct. 25, 2004, the entire teachings of which are incorporated herein by reference.

### BACKGROUND OF THE INVENTION

1. Statement of the Technical Field

The present invention relates to the field of pattern creation and more particularly to a method for creating a pattern solution. Patterns have historically been useful in the software development process, where specific software design patterns and pattern languages have been developed.

2. Description of the Related Art

Patterns describe a problem and a general solution for the problem in a particular context. Patterns have been formalized by some as a three-part rule which expresses a relation between a certain context, a problem and a solution. Patterns are useful in addressing recurring design problem/solution pairs. Pattern development has its history in the study of architecture where Christopher Alexander et al's. 1977 book: A Pattern Language: Towns, Buildings, Construction (Center for Environmental Structure Series) describes patterns for solving recurring problems in urban architectural design.

In the computer field, patterns have been used to aid the software development process. Design Patterns—Elements of Reusable Object-Oriented Software by Erich Gamma, Richard Helm, Ralph Johnson and John Vlissides (1996, Addison-Welsey) defines creation patterns, structural patterns and behavioral patterns for software development. Core J2EE Patterns—Best Practices and Design Strategies by Deepak Alur, John Crupi and Dan Malks (2001, Sun Microsystems Press) describes patterns useful in the Java programming environment.

Patterns have been collected into catalogs. Patterns have also been combined to form pattern languages that define a set of reserves words (a language) for expressing a solution to a problem. Patterns languages lack organization, ordering and substitution of the combines patterns. Pattern languages in the computer field have also been focused mainly on software design and software development. Patterns usage for other aspects of the software life cycle, such as application infrastructure, application deployment and business process integration have been largely ignored.

### SUMMARY OF THE INVENTION

The present invention provides organization, ordering and substitution capabilities to a grouping of patterns via a recipe. A combined group of patterns and recipe form a pattern solution. Pattern solutions are applicable beyond just software design and development and can include other aspects of the software life cycle, such as application infrastructure, application deployment and business process integration.

The present invention provides a method, apparatus and computer program product for creating and implementing a pattern solution by specifying one or more patterns and creating a pattern solution recipe which documents guidance related to use, organization and interconnection the patterns. The pattern solution recipe permits substitution of one or more specified pattern with a substitute pattern. The pattern solution is transformed (creating a pattern solution implementation) by implementing each pattern as a parameterizable computer accessible object. These parameters provide a point of customization. The pattern solution recipe is implemented as another computer accessible object providing further refined guidance on the use of the implemented pattern solutions. Pattern solutions knit many patterns together using the pattern solution recipe.

In a preferred aspect of the invention, guidance includes ordering information related to the use of the specified patterns. In another preferred aspect of the invention, the computer accessible objects are stored in accordance with the Object Management Group Reusable Asset Specification (e.g., OMG Adopted Specification ptc/Apr. 6, 2006).

Advantages of the present invention included the ability to scale to support larger-grained solutions. The ability to substitute ingredients (i.e., patterns, assets) for a particular solution provides flexibility. The present invention reduces the effort of applying patterns by reducing the amount of “hunting and pecking” required to figure out how to pull the patterns together. Using existing ingredients for the recipe (i.e., the service and component assets which implement patterns) increases the likelihood of the final solution being successful because the ingredients are often already proven sub-solutions themselves.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a computer system which has been configured in accordance with the present invention;

FIG. 2 is a diagram of the internal structure of a computer in the computer system of FIG. 1;

FIG. 3 is a flow chart illustrating a process for creating and implementing a pattern solution; and

FIG. 4 is pictorial illustration of a pattern solution and its transformation into a pattern solution implementation.

### DETAILED DESCRIPTION OF THE PREFERRED EMBODIMENTS

The present invention is a method, apparatus and computer program product for creating and implementing a pattern solution. A description of the preferred embodiments of the invention follows.

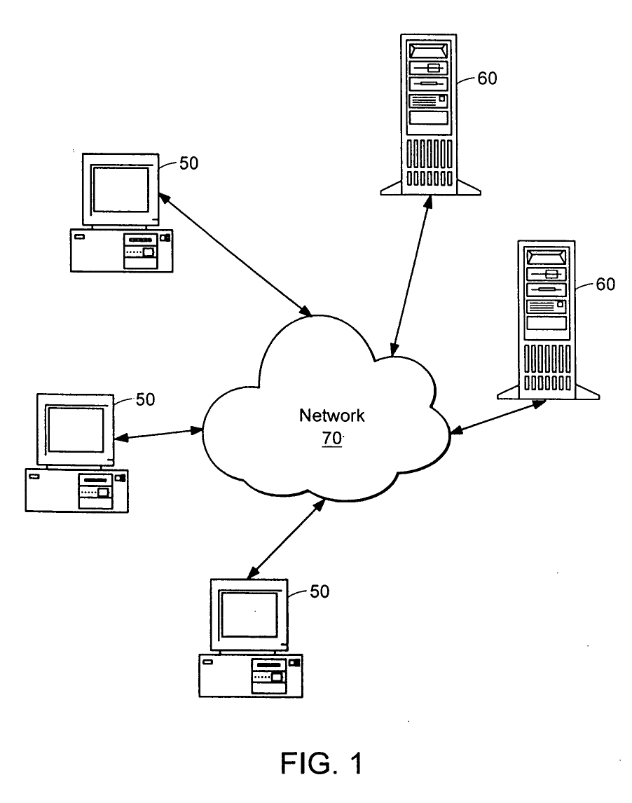

FIG. 1 is a pictorial illustration of a computer system which has been configured in accordance with the present invention. Client computer 50 and server computer 60 provide processing, storage, and input/output devices for creating and implementing a pattern solution. The client computers 50 can also be linked through a communications network 70 to other computing devices, including other client computers 50 and server computers 60. The communications network 70 can be part of the Internet, a worldwide collection of computers, networks and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. In another embodiment of the present invention, creating and implementing a pattern solution can be implemented on a stand-alone computer.

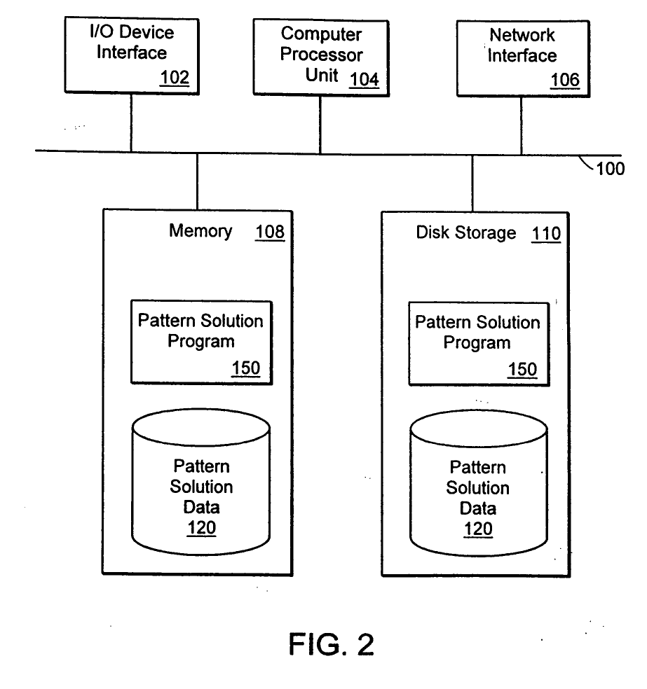

FIG. 2 is a diagram of the internal structure of a computer (50, 60) in the computer system of FIG. 1. Each computer contains a system bus 100, where a bus is a set of hardware lines used for data transfer among the components of a computer (50, 60). A bus 100 is essentially a shared conduit that connects different elements of a computer system (e.g., processor, disk storage, memory, input/output ports, network ports, etc.) that enables the transfer of information between the elements. Attached to system bus 100 is an I/O device interface 102 for connecting various input and output devices (e.g., displays, printers, speakers, etc.) to the computer. A network interface 106 allows the computer to connect to various other devices attached to a network (e.g., network 70). A memory 108 provides volatile storage for computer software instructions (e.g., Pattern Solutions Program 150) and data (e.g., Pattern Solution Data 120) used to implement an embodiment of the present invention. Disk storage 110 provides non-volatile storage for computer software instructions (e.g., Pattern Solutions Program 150) and data (e.g., Pattern Solution Data 120) used to implement an embodiment of the present invention.

A computer processor unit 104 is also attached to the system bus 100 and provides for the execution of computer instructions (e.g., Pattern Solutions Program 150) and data access (e.g., Pattern Solution Data 120), thus allowing the computer to create and implement a pattern solution.

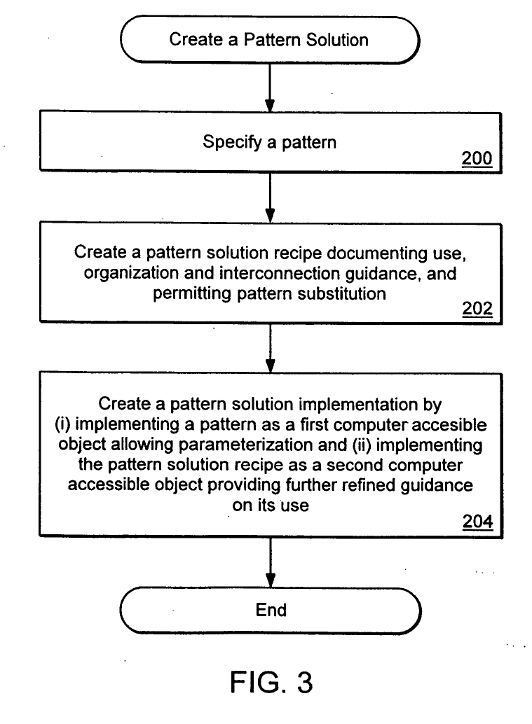

FIG. 3 is a flow chart illustrating a process for creating and implementing a pattern solution. At step 200 a pattern or patterns are specified. The pattern(s) many be preexisting pattern(s) (e.g., a design pattern such the Abstract Factory creational pattern by Gama, et al.). A new pattern may also be authored at this point to solve a particular problem. As few as one pattern, or as many patterns as are needed, can become part of the pattern solution being created. At step 202 a pattern solution recipe is created. The pattern solution recipe provides documentation on the use, organization and interconnection of the specified patterns in the pattern solution. In a preferred embodiment of the present invention, the order in which the specified patterns are applied is part of the use information. The pattern solution recipe can also contain interconnection guidance. In one embodiment the interconnection guidance can help align the outputs of one pattern with the inputs of another pattern. The ability to substitute one (or more) pattern for another (or more) pattern provides flexibility in the design of the pattern solution. Substitution guidance is documented in the pattern solution recipe.

Transforming a pattern solution into a pattern solution implementation is performed at step 204 by implementing a pattern as a computer accessible object such that it can be parameterized to affect its use. Additionally, the pattern solution recipe is implemented as another computer accessible object which provides further refined guidance on the use of the implemented patterns.

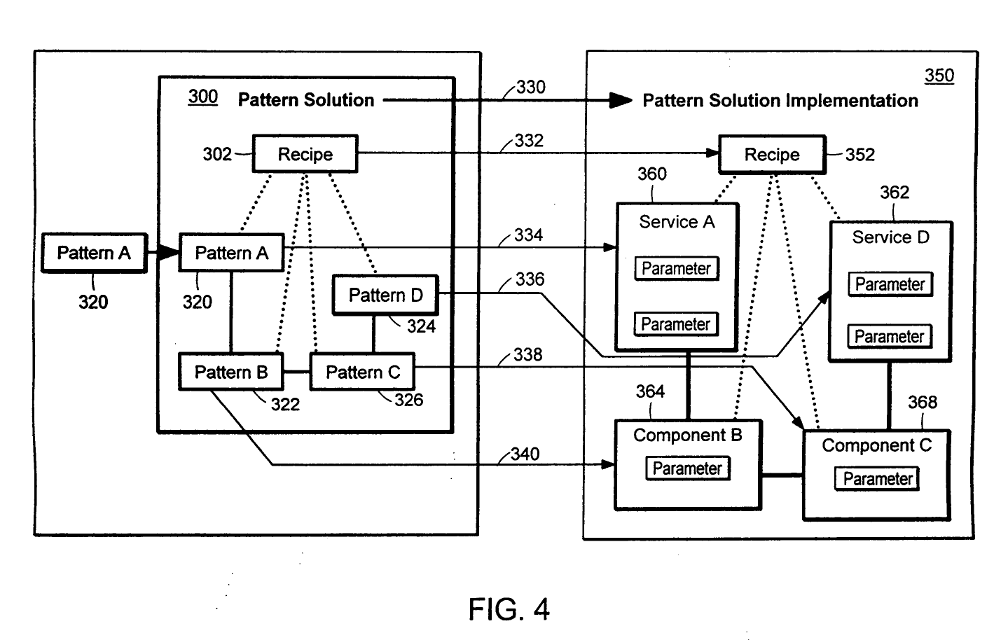

FIG. 4 is pictorial illustration of a pattern solution 300 and its transformation (330) into a pattern solution implementation 350. A pattern solution 300 contains a recipe 302 and a series of patterns: pattern A 320, pattern B 322, pattern C 326 and pattern D 324.

Pattern A 320 is shown as originating at a different source and being pulled into pattern solution 300.

Pattern solutions 300 are very useful in the creation of computer software solutions. There are many software artifacts and software assets (e.g., Service A 360, Component B 364, Component C 368 and Service D 362) which are used to create a software solution. Organizations spend significant resources on creating software solutions to their business problems over and over. There is some commonality across many of these solutions, and yet there is the need for some customization and modification for each specific implementation of a software solution. This requires the pieces and parts (the software artifacts and assets) of the software solution to be interchangeable and customizable across multiple solutions. Additionally, the ultimate user (e.g., a software developer or software architect) is left with the burden of figuring out how to bring the software artifacts and assets together, and in what order, to implement the solution. The present invention pulls software artifacts and assets together in the proper order with the necessary guidance for the user while allowing the artifacts and assets to be swapped in and out of the solution. The software artifacts and assets pulled together are implementations of patterns (e.g., pattern A 320, pattern B 322, pattern C 326 and pattern D 324). Patterns describe solutions to recurring problems for a particular context and and pattern solutions (e.g., pattern solution 300) knit many patterns together (i.e., artifacts and assets) using a recipe 302, containing the guidance to use the patterns (302-326) in the proper order. A pattern solution recipe 302 is transformed into a pattern solution implementation recipe 352 via transformation 332. Pattern are transformed via transformations into an implementation.

Transformations (e.g., transformations 330-340) can be text-to-text transformations where further refinement (e.g., “an implementation of this pattern can be in this repository at this website”) on the guidance for use of a pattern results (e.g., an XML file). A transformation can also be the implementation of a pattern (e.g., pattern C 326) into a standard programming language (e.g., C, C++, Java) with further transformation (e.g., compliation) into an executable computer object (e.g., component C 368). Referring to FIG. 4; pattern A 320 is transformed via transformation 334 to service A 360, pattern B 322 is transformed via transformation 340 to component B 364, pattern C 326 is transformed via transformation 338 to component C 368 and pattern D 324 is transformed via transformation 336 to service D 362.

Patterns (320-326) and pattern solutions 300 are generally described using text. A pattern solution recipe 302 can also be described using some structured text in terms of required and necessary elements that should be captured (e.g., use, organization and interconnection guidance). Any of the software artifacts or assets, including the pattern solution implementation recipe 352 can be packaged using the Object Management Group's (OMG) Reusable Asset Specification (RAS). RAS can be extended to describe various types of software artifacts or assets. In one embodiment a RAS document can be instantiated as an XML document. The pattern solution implementation recipe 352 can be created as is a special kind of asset which knits many other assets (e.g., implemented patterns) together.

In a preferred embodiment the invention works by starting with descriptions for each of the relevant patterns (320-326) identified for a particular pattern solution 300. The pattern solution recipe 302 pulls these descriptions together, describing a more coarse-grained solution. The pattern solution recipe 302 describes how the patterns (320-326) connect, when to use them, and in what manner. The pattern solution 300 is transformed (330) into a pattern solution implementation 350. The pattern solution implementation 350 consists of implementations of the relevant patterns (320-326), as services (e.g., service A 360, service D 362), components (e.g., component B 264, component C 368), and so on, producing software artifacts. The pattern solution implementation recipe 352 identifies the location of the pattern implementations (i.e., services, component, etc.). In one preferred embodiment the locations are links/pointers to software repositories (e.g., URLs pointing to RAS repositories). Other information stored in a pattern solution implementation recipe 352 can include a name of the pattern solution and a general description of the solution itself, as well as links/pointers to additional documentation. The pattern solution implementation recipe 352 can be structured using a RAS profile. The RAS profile is an XML schema document, from which a specific XML document is created, one per solution, to capture the pattern solution implementation recipe 352. A pattern solution implementation recipe 352 further refines, according to some context (e.g., a specific operating platform, known user sophistication, a particular development environment, a particular deployment environment or particular business/domain contexts), the guidance information (e.g., on a particular operating environment with users a certain level of user sophistication a system response time of 2 seconds is acceptable). Another way of describing a pattern solution implementation recipe 352 is that it binds more constraints to the guidance from the pattern solution recipe 302.

One way to view the process of creating and implementing a pattern solutions is to examine a exemplary workflow, identifying typical roles of uses at various points. In one embodiment of the present invention the roles of “solution designer,” “solution assembler,” and “solution implementer” are illustrative. A solution designer creates the pattern solution 300 by pulling together a variety of new and existing patterns (320-326) to solve a problem and creating a pattern solution recipe 302 containing guidance on how to use the patterns (320-326). The solution designer can be viewed as seeing the ultimate solution in the abstract. The solution designer has access to some tooling that helps with the creation, editing and storage of the pattern solution 300. For example, the pattern solution can be stored as an XML formatted file with a file extension of “.ps”.

The ps file containing the pattern solution 300 can be used as input to a solution assembler. The solution assembler assembles a pattern solution implementation by further refining the guidance of the pattern solution recipe 302 and further refining the definition of the patterns (320-326). These further refinements can take the form of location information detailing where an implementation of a particular pattern can be found. Further refinements to the pattern solution implementation recipe 352 can take the form of context specific information based on how/where the solution will be deployed. The solution assembler may also have access to some tooling that helps with the creation, editing and storage of the pattern solution implementation 350. For example, the pattern solution can be stored as an XML formatted file with a file extension of “.psi”. As with the ps file, the psi file can be stored in a RAS repository.

The psi file containing the pattern solution implementation can be used as input to a solution implementer. The solution implementer builds the actual solution. In the case of a computer system solution this may be an executable computer program or system of programs (e.g., a jar file).

A fundamental element to RAS is the fact that you can identify the context for which the asset can be (re)used. Context can be development context (e.g., J2EE), deployment context (e.g., WebSphere), domain context (e.g., financial services), and so on. The notion of context directly impacts the organization of the recipes (e.g., pattern solution 302 or pattern solution recipe 352). If you are going to apply a recipe in a certain context, it can/does directly affect the recipe in terms of steps that may be skipped, ingredients/assets that may be used or avoided, and so on. For this reason, the notion of substituting ingredients/assets in a recipe is important to the invention, because one cannot always plan on the context within which the recipe can be used.

Pattern solutions can be used to solve non-computer related problems as well. An illustrative, non-technical, example follows. Imagine the problem space to be the planning of a dinner party. The problem statement identifies a need for a delicious cake for dessert at the dinner party. A solution designer (party planner) can create a pattern solution comprising patterns for a 3-tier yellow cake with chocolate frosting and white candy decorations—the “cake pattern solution.” The patterns can be based on existing patterns for desserts (e.g., ways of making/acquiring 3-tier yellow cake and chocolate frosting may be readily available), but a new pattern for the solution to the white candy decoration may have to be created from scratch. A solution assembler (chef) can take the cake pattern solution and implement it by transforming the patterns specified by the solution designer into more refined instruction (i.e., a conventional food recipe). The conventional food recipe (pattern solution implementation) may contain a list of ingredients and instructions on how and when to combine them as well was what to do with them once combine (e.g., bake them). Additional context guidance may be provided (e.g., a cake baked at high altitude may require more baking time). A solution implementer (line cook) can take the pattern solution inplementation (conventional food recipe) and build (bake) it. Thus it can be seen that creating and implementing pattern solutions is applicable to many problems.

As will be understood by one of ordinary skill in the art, the various roles described may be performed by a human or an automated process or apparatus. Additionally, one person/process can perform many roles.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. When embodied as a computer program product, the present invention can be recorded in memory (e.g., memory 108 ) or disk storage (e.g., disk storage 110). Disk storage can include CD-ROM, DVD, floppy disk drives or any other recordable media. When embodied as a computer data signal, the present invention can be encoded on any carrier wave medium (e.g., Ethernet, wireless network or any other data transport mechanism). Significantly, this invention can be embodied in other specific forms without departing from the spirit or essential attributes thereof, and accordingly, reference should be had to the following claims, rather than to the foregoing specification, as indicating the scope of the invention.

While this invention has been particularly shown and described with references to preferred embodiments thereof, it will be understood by those skilled in the art that various changes in form and details may be made therein without departing from the scope of the invention encompassed by the appended claims.

We claim:

1. A method for creating and implementing a pattern solution, comprising the steps of:
(a) specifying a least one pattern;
(b) creating a pattern solution recipe which documents guidance related to use, organization and interconnection of the at least one pattern, the pattern solution recipe permitting substitution of at least one of the at least one pattern with a substitute pattern;
(c) creating a pattern solution implementation comprising the steps of:
(i) implementing the at least one pattern as a first computer accessible object such that the first computer accessible object can be parameterized to affect its use; and
(ii) implementing the pattern solution recipe as a second computer accessible object such that the second computer accessible object provides further refined guidance on the use of at least one of the first computer accessible object.

2. The method of claim 1 wherein the guidance includes ordering information.

3. The method of claim 1 wherein the guidance includes context information.

4. The method of claim 3 wherein the context information includes at least one of:
development context information, deployment context information or domain context information.

5. The method of claim 1 wherein at least one of the first computer accessible object or the second computer accessible object are stored in accordance with the Object Management Group Reusable Asset Specification.

6. A computer program product comprising a computer readable medium containing a set of computer program instructions for creating and implementing a pattern solution, including instructions to:
(a) specify a least one pattern;
(b) create a pattern solution recipe which documents guidance related to use, organization and interconnection of the at least one pattern, the pattern solution recipe permitting substitution of at least one of the at least one pattern with a substitute pattern;
(c) create a pattern solution implementation comprising the steps of:
(i) implementing the at least one pattern as a first computer accessible object such that the first computer accessible object can be parameterized to affect its use; and
(ii) implementing the pattern solution recipe as a second computer accessible object such that the second computer accessible object provides further refined guidance on the use of at least one of the first computer accessible object.

7. The computer program product of claim 6 wherein the guidance includes ordering information.

8. The computer program product of claim 6 wherein the guidance includes context information.

9. The computer program product of claim 8 wherein the context information includes at least one of: development context information, deployment context information or domain context information.

10. The computer program product of claim 6 wherein at least one of the first computer accessible object or the second computer accessible object are stored in accordance with the Object Management Group Reusable Asset Specification.

11. A computer data signal embodied in a carrier wave comprising a code segment for creating and implementing a pattern solution, the code segment including instructions to:
(a) specify a least one pattern;
(b) create a pattern solution recipe which documents guidance related to use, organization and interconnection of the at least one pattern, the pattern solution recipe permitting substitution of at least one of the at least one pattern with a substitute pattern;
(c) create a pattern solution implementation comprising the steps of:
(i) implementing the at least one pattern as a first computer accessible object such that the first computer accessible object can be parameterized to affect its use; and
(ii) implementing the pattern solution recipe as a second computer accessible object such that the second computer accessible object provides further refined guidance on the use of at least one of the first computer accessible object.

12. The computer data signal of claim 1 1 wherein the guidance includes ordering information.

13. The computer data signal of claim 11 wherein the guidance includes context information.

14. The computer data signal of claim 13 wherein the context information includes at least one of: development context information, deployment context information or domain context information.

15. The computer data signal of claim 11 wherein at least one of the first computer accessible object or the second computer accessible object are stored in accordance with the Object Management Group Reusable Asset Specification.

16. A data processing system for creating and implementing a pattern solution, comprising:
(a) computer processor means for processing data;
(b) storage means for storing data on a storage medium;
(c) first means for specifying a least one pattern;
(d) second means for creating a pattern solution recipe which documents guidance related to use, organization and interconnection of the at least one pattern, the pattern solution recipe permitting substitution of at least one of the at least one pattern with a substitute pattern;
(e) third means for creating a pattern solution implementation further comprising:
(i) fourth means for implementing the at least one pattern as a first computer accessible object such that the first computer accessible object can be parameterized to affect its use; and
(ii) fifth means for implementing the pattern solution recipe as a second computer accessible object such that the second computer accessible object provides further refined guidance on the use of at least one of the first computer accessible object.

17. The data processing system of claim 16 wherein the guidance includes ordering information.

18. The data processing system of claim 16 wherein the guidance includes context information.

19. The data processing system of claim 18 wherein the context information includes at least one of: development context information, deployment context information or domain context information.

20. The data processing system of claim 16 wherein at least one of the first computer accessible object or the second computer accessible object are stored in accordance with the Object Management Group Reusable Asset Specification.
